(19) United States
(12) Patent Application Publication
(10) Pub. No.: US 2022/0129307 A1
(43) Pub. Date: Apr. 28, 2022

(54) DISTRIBUTING PROCESSING OF JOBS ACROSS COMPUTE NODES

(71) Applicant: HEWLETT PACKARD ENTERPRISE DEVELOPMENT LP, Houston, TX (US)

(72) Inventors: David G. Strenski, Ypsilanti, MI (US); Ting-Ting Zhu, Bloomington, MN (US); David L. Whitaker, Bloomington, MN (US); Jacob A. Balma, Bloomington, MN (US); Jeffrey M. Dawson, Bloomington, MN (US)

(21) Appl. No.: 17/082,562

(22) Filed: Oct. 28, 2020

(51) Int. Cl. G06F 9/48; G06F 9/50

(52) U.S. Cl. CPC G06F 9/4881; G06F 9/5077; G06F 2209/505; G06F 2209/483; G06F 9/5072

(57) ABSTRACT

A technique includes receiving a request to process a job on a cluster. The job includes a plurality of ranks, the cluster includes a plurality of nodes, and the plurality of ranks can be equally divided among a minimal subset of nodes of the plurality of nodes such that all processing cores and the minimal set of nodes correspond to the plurality of ranks. The technique includes, in response to the request, scheduling processing of the job. The scheduling of the processing of the job includes distributing processing of the plurality of ranks across a set of nodes of the plurality of nodes greater in number than the minimal subset of nodes.

### BACKGROUND

A high performance, parallel processing computing system may include a group of compute nodes and a scheduler that schedules the work that is performed by the compute nodes. Each compute node may contain a set of processing cores (e.g., central processing unit (CPU) cores); and the work may be organized as jobs (e.g., message passing interface (MPI) jobs), which may be submitted by applications. A given job may be divided into a set of ranks (e.g., MPI ranks), or processes. Each rank of a given job may be processed in parallel with the other ranks of the job. The scheduler schedules, or assigns, the ranks of each job to different processing cores of the computing system.

### BRIEF DESCRIPTION OF THE DRAWINGS

FIG. 1 is a schematic diagram of a system according to an example implementation.

FIG. 2 is an illustration of job scheduling including job striping-based scheduling for different numbers of jobs per compute node according to example implementations.

FIG. 3 is an illustration of the compute nodes of the cluster of FIG. 1 according to an example implementation.

FIG. 4 is a flow diagram depicting the scheduling of jobs by a scheduler of the cluster of FIG. 1 according to an example implementation.

FIG. 5 is an illustration of job striping-based scheduling according to an example implementation and the comparison of the job striping-based scheduling to node packing-based scheduling.

FIG. 6 is a flow diagram depicting a process to schedule processing of a job on nodes according to an example implementation.

FIG. 7 is a schematic diagram of a system to schedule processing of a job on nodes according to an example implementation.

FIG. 8 is an illustration of machine-readable instructions stored on a non-transitory storage medium that, when executed by a machine, cause the machine to schedule processing of jobs on nodes according to an example implementation.

### DETAILED DESCRIPTION

A high performance computing system, such as a high performance cluster, may contain a set of compute nodes. In this context, a “node” or “compute node” refers to an entity that includes multiple processing cores (e.g., central processing unit (CPU) cores, graphics processing unit (GPU) cores, field programable gate arrays (FPGAs), or other node accelerator cores) and corresponds to a single operating system (OS) instance. In general, an application may submit a unit of work called a “job” to the computing system, and a scheduler of the computing systems schedules different parts of the job to be performed by the processing cores of one or multiple compute nodes of the computing system.

In accordance with example implementations, each “job” may be divided into a set of parallel processes, or “ranks.” In accordance with example implementations, each rank corresponds to a process and corresponds to a unit of machine-executable instructions that may be executed, or processed, by a processing core (or a group of processing cores); and the ranks of a job may be processed in parallel by the processing cores that are individually assigned to the ranks. As a more specific example, for a computing system that has a distributed memory environment and adheres to the message passing interface (MPI) protocol communication standard, the job may be an MPI job, which has a number of MPI ranks.

The computing system may have a workload scheduler, or “scheduler,” for purposes of assigning, or scheduling, the ranks of the jobs to the processing cores. As an example, a particular application may have a set of computationally intensive tasks (e.g., tasks corresponding to fluid dynamics computations), and the application may submit a job to the computing system, where the ranks of the jobs correspond to different parallel processes involved in performing these computationally intensive tasks. In general, the scheduler assigns each rank to one processing core.

At any one time, the computing system may be processing multiple jobs; and there may be multiple jobs waiting to be processed. The waiting jobs may be arranged in job batch queues (e.g., first in first out (FIFO) queues), with the job batch queues having different priorities. As an example, a script may execute on a client that has a job to be processed on the computing system. The script may, for example, select a particular job batch queue and submit the job to the selected job batch queue. The script may also select one or multiple preferences of a job scheduling policy to be used by the scheduler in the scheduling of the job, as further described herein. For a given incoming job, the scheduler may assign a particular job identifier (JID) to the job, communicate the JID back to the client, and schedule the processing of the job, taking the requested scheduling policy preferences into consideration.

The scheduler schedules the ranks of the job across multiple processing cores and may schedule processing of the ranks across multiple compute nodes, i.e., processing cores of one or multiple compute nodes may process the ranks of the job in parallel. The scheduler may schedule groups of jobs at a time, such as, for example, a batch of jobs that are present in a job batch queue.

For purpose of scheduling jobs on a particular group of compute nodes that are idle or will be idles when processing of the jobs begins, the scheduler may apply a job scheduling policy. In this context, a “job scheduling policy” refers to criteria that the scheduler applies when assigning ranks of one or multiple jobs to different processing cores of the cluster.

One potential way for the scheduler to schedule a batch of jobs for processing on a group of compute nodes is apply what is referred to as “node packing-based scheduling” herein. With node packing-based scheduling, the goal is to pack jobs on the minimal number of compute nodes that may process the jobs; and with node packing-based scheduling, each compute node may be scheduled to process the ranks of a single job (i.e., one job per compute node). Moreover, because the number of ranks of a job may exceed the number of processing cores per compute node, the node packing-based scheduling may assign a single job to multiple compute nodes, where each compute node processes a different set of ranks for the job.

As an example of node packing-based scheduling, if there are thirty-two processing cores per compute node, then the scheduler may, for a job having sixty-four ranks, select two idle compute nodes and may assign all sixty-four ranks to these two compute nodes, i.e., the scheduler may, for example, assign thirty-two ranks to the thirty-two processing cores of one compute node and assigns the other thirty-two ranks to the thirty-two processing cores of the other compute node. As another example, if a particular job has forty-eight ranks, then, pursuant to the node packing-based scheduling, the scheduler may assign thirty-two ranks to the thirty-two processing cores of one compute node and assign the remaining sixteen ranks to the sixteen processing cores of another compute node.

In general, node packing-based scheduling is based on the premise that job processing performance is enhanced by minimizing inter-compute node communications (i.e., minimizing “off node” communications) in the processing of the job. In words, node packing-based scheduling assumes that by packing the ranks of a job into the minimal set of compute nodes, the sharing of resources (e.g., memory) on each compute node is maximized, which supposedly results in the best job processing performance (e.g., the least overall processing time for the job).

In accordance with example implementations that are described herein, a scheduler uses job striping-based scheduling. In this context, “job striping-based scheduling” refers to a scheduling that distributes, or “stripes,” the ranks of a job across a set of compute nodes, where the set of compute nodes is greater in number than the minimal set of compute nodes that can accommodate processing of all of the ranks of the job. As a consequence of job striping-based scheduling, a given compute node may simultaneously process ranks of multiple jobs.

With the job striping-based scheduling, off node communications increase, as the ranks are processed on more than the minimal set of compute nodes (i.e., more than the minimal set of compute nodes used by node packing-based scheduling). However, the job striping-based scheduling has processing performance enhancement factors that may offset or exceed any processing performance detriment caused by the increased off node communications. For example, the job striping-based scheduling results in individual compute nodes each processing the ranks of different jobs in parallel, adding another level of parallelism. Assuming that, for example, that sixteen ranks of Job A and sixteen ranks of Job B are executing in parallel on the same compute node, the asynchronous nature of the ranks of Job A relative to the ranks of Job B may result in a reduced contention for local resources (e.g., local processing, local cache, local memory and network communication) on the compute node, as compared to, for example, thirty ranks of the same job executing in parallel on the compute node. Moreover, executing ranks of multiple jobs on the same compute node may results in better cache utilization (e.g., a higher number of cache hits). Accordingly, although the job striping-based scheduling may increase off node communications as compared to node packing-based scheduling, processing performance may nevertheless be improved. Moreover, the job striping-based scheduling may result in a better system throughput, as the system is able to perform more work (i.e., process more jobs) per day.

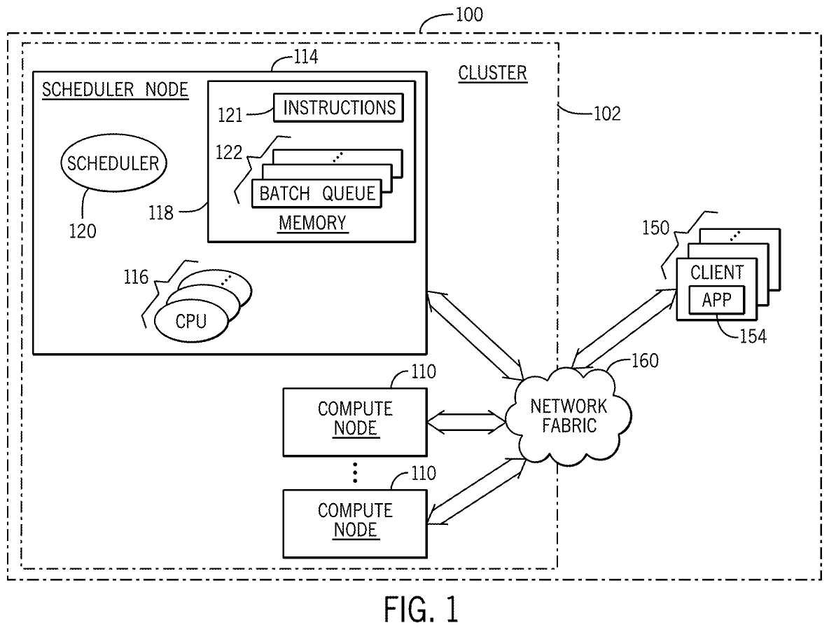

As a more specific example, FIG. 1 illustrates a system 100 in accordance with some implementations. Referring to FIG. 1, the system 100 includes a high performance computing system, such as a cluster 102. The cluster 102 includes a scheduler node 114 and multiple compute nodes 110. In general, the compute nodes 110 may process jobs that are submitted by clients 150. In this manner, a given client 150 may execute one or multiple software programs, or applications 154, that produce jobs (e.g., MPI jobs), where each job contains a set of ranks (e.g., MPI ranks). The scheduler node 114 may contain one or multiple batch queues 122 (e.g., queues 122 corresponding to different priorities), and a given client 150 may, for example, execute a script to submit a given job one of the batch queues 122, which may also include submitting one or multiple user-specified options for the scheduling. The scheduler node 114 may assign an JID to the job, which the scheduler node 114 sends to the client 150; and the scheduler node 114 applies a job striping-based scheduling policy based on the user specified options to schedule processing of the ranks of the job to processing cores of a set of the compute nodes 110. After the compute nodes 110 process the job, the scheduler node 114 may return the results to the client 150 by storing the results in an output queue (not shown), along with the assigned JID.

In accordance with example implementations, the scheduler node 114 may be formed from an actual physical machine that is made from actual software and actual hardware. For example, the scheduler node 114 may include one or multiple central processing units (CPUs) 116 and a memory 118. As an example, the memory 118 may store machine executable instructions 121 that, when executed by the CPU(s) 116, form a scheduler 120 that schedules jobs based on a job striping-based scheduling policy. Moreover, the memory 118 may store the batch queues 122; output, or result queues; as well as other and/or different data.

The memory 118, in general, is a non-transitory storage medium that may be formed from semiconductor storage devices, memristor-based storage devices, magnetic storage devices, phase change memory devices, a combination of storage devices corresponding to one or more of these storage technologies, and so forth. Moreover, the memory 118 may be a volatile memory, a non-volatile memory, or a combination of different storage types, such as a volatile memory and/or a non-volatile memory.

The physical machine from which the scheduling node 114 is formed may take on one of many different forms, such as one or multiple rack-mounted modules, one or multiple server blades, a desktop computer, a laptop computer, a tablet computer, a smartphone, a wearable computer, and so forth. Depending on the particular implementation, the scheduler node 114 may be formed from an entire actual physical machine or a portion thereof. Moreover, in accordance with some implementations, the scheduler node 114 may include and/or correspond to one or multiple virtual components or one or multiple virtual environments of an actual physical machine, such as one or multiple virtual machines, one or multiple containers, and so forth.

The compute nodes 110 may also be formed from corresponding actual physical machines; may or may not correspond to the entirety of their corresponding physical machines; and may include and/or correspond to one or multiple virtual components or virtual environments of their corresponding physical machines. Regardless of the particular form of the compute node 110, in accordance with example implementations, the compute node 110 includes multiple processing cores, and possibly node accelerators, such as GPU processing cores and/or FPGAs, which contain processing cores that collectively execute a single OS instance.

As depicted in FIG. 1, in accordance with example implementations, the scheduler node 114, compute nodes 110, and clients 150 may communicate with each other via network fabric 160. In general, the network fabric 160 may include components and use protocols that are associated with one or multiple types of communication networks, such as (as examples) Fibre Channel networks, iSCSI networks, ATA over Ethernet (AoE) networks, HyperSCSI networks, InfiniBand networks, Gen-Z fabrics, dedicated management networks, local area networks (LANs), wide area networks (WANs), global networks (e.g., the Internet), wireless networks, or any combination thereof.

The scheduler 120 performs the job striping-based scheduling based on a scheduling policy (also referred to herein as a “job striping-based scheduling policy”). In general, the scheduling policy sets forth preferences that guide the job scheduler 120 in the striping of jobs across the compute nodes 110. The scheduling policy may be based on a number of different factors, such as characteristics of the compute nodes 110 (e.g., the number of processing cores per compute node 110), characteristics of a batch of jobs to be scheduled, default scheduling preferences, user-specified scheduling preferences, and so forth. In accordance with some implementations, the scheduler 120 may determine one or multiple preferences of the scheduling policy based on the characteristics of a particular group, or batch, of jobs to be scheduled.

In accordance with example implementations, the job striping-based scheduling policy may specify a first preference to stripe, or distribute, the job over a certain minimum number of processing cores per compute node 110 (of the compute nodes 110 over which the job is striped); and the job striping-based scheduling policy may specify a second preference to stripe the job over a certain number of compute nodes 110. As a specific example, the job striping-based scheduling policy may specific a preference that the job is be striped across at least four processing cores per compute node 110 and a preference that the job is be striped across eight compute nodes 110. Therefore, for these preferences and compute nodes 110 that each have thirty-two processing cores, the scheduler 120 may, for example, stripe a job of 128 ranks across eight compute nodes 110 (i.e., the scheduler 120 may assign sixteen ranks to sixteen processing cores per compute node 110), even though the 128 ranks could be packed into four compute nodes 110 (i.e., the minimal set, if node packing-based scheduling were used).

For a given batch of jobs, the scheduler 120 may determine one or multiple preferences of the job striping-based scheduling policy based on characteristics of the jobs. This determination may, for example, adjust a minimal number of processing cores per compute node preference and/or a number of compute nodes per job stripe preference based on characteristics of the jobs in the batch. For example, there may be thirty-two processing cores per compute node, and most of the jobs in a particular batch of jobs may have thirty-two ranks or more, with some jobs having, for example, 128 ranks. Therefore, based on this particular batch of jobs, the scheduler 120 may, for example, determine a minimum number of processing cores per compute node of four and a minimal number of compute nodes per stripe of eight. Although this particular job scheduling policy accommodates the characteristics of the compute nodes and most of the jobs to be scheduled in the batch, it may not be possible to schedule some of the jobs of the batch according to the preferences. For such cases, the scheduler 120 may schedule the processing of such jobs according to an alternative policy that still conforms at least to some degree to the original job scheduling policy. For example, in accordance with some implementations, the scheduler 120 may determine an alternative job scheduling policy that most closely conforms to the original job scheduling policy for the batch of jobs.

In accordance with some implementations, the scheduler 120 may determine the alternate job scheduling policy by considering the scheduling preferences of the originally determined scheduling policy in a certain order (e.g., an order set by priorities that are assigned to the preferences). For example, in accordance with some implementations, the scheduler 120 may determine processing core assignments for a given job that first satisfy a minimal processing core number per compute node preference and then secondly, satisfy a number of compute nodes 110 per job stripe preference.

As a more specific example, a job may include twenty ranks; and the job striping-based scheduling policy may specific a preference that the job is be striped across at least four processing cores per compute node 110, and the policy may specify a preference that the job is be striped across eight compute nodes 110. A stripe across eight compute nodes 110 corresponds to thirty-two processing cores, i.e., a number less than the twenty ranks of the job for this example. Therefore, here, the scheduler 120 cannot satisfy both preferences of the job striping-based scheduling policy; and the scheduler 120 instead satisfies the first preference and stripes the twenty rank job across five compute nodes 110 at four ranks per compute node 110.

One or multiple preferences of the job striping-based scheduling policy may be set by default preferences, user-specified preferences, or a combination of default and user-specified preferences, depending on the particular implementation. In accordance with some implementations, the scheduler 120 may have certain default preferences for the job striping-based scheduling policy based on characteristics of the compute nodes 110, such as the number of processing cores per compute node 110, resources (e.g., cache sizes) per compute node, processing core processing power, and so forth. The scheduler 120 may override a given default preference based on a user specified preference. For example, a client 150 may submit a job request for a thirty-two rank job and specify with the request a preference for striping the job at a minimum of eight processing cores per compute node 110. For this example, the scheduler 120 may stripe the thirty-two rank job across four compute nodes 110. As described above, in accordance with some implementations, the scheduler 120 may determine and/or modify one or multiple preferences of the job striping-based scheduling policy based on characteristics of a particular batch of jobs to be scheduled.

In accordance with further example implementations, the scheduler 120 may modify (e.g., determine independently, adjust a previously-determined preference, and so forth) one or multiple preferences of the job striping-based scheduling policy on one or multiple performance metrics. For example, in accordance with some implementations, the scheduler 120 may observe over time that job processing times are the lowest for a certain minimum number of processing cores per compute node 110 per job stripe and/or for a certain number of compute nodes 110 per job stripe. In accordance with some implementations, the scheduler 120 may vary certain default preferences of the job striping-based scheduling policy over time (e.g., vary over the course of days or weeks), observe corresponding effects on job processing performance metrics, and adapt one or multiple preferences of the scheduling policy based on the observed effects to optimize job processing performance.

In accordance with some implementations, the scheduler 120 may set one or multiple particular preferences for the job striping-based scheduling policy based on one or multiple characteristics of the job or jobs being scheduled. As examples, the scheduler 120 may set a particular number of compute nodes 110 per job stripe based on a particular classification of the job (e.g., a certain number of compute nodes 110 per job stripe for fluid dynamics processing jobs); set a particular minimum number of processing cores per compute node 110 per job stripe based on a particular user identifier, or “UID;” application identifier, or “AID;” and so forth.

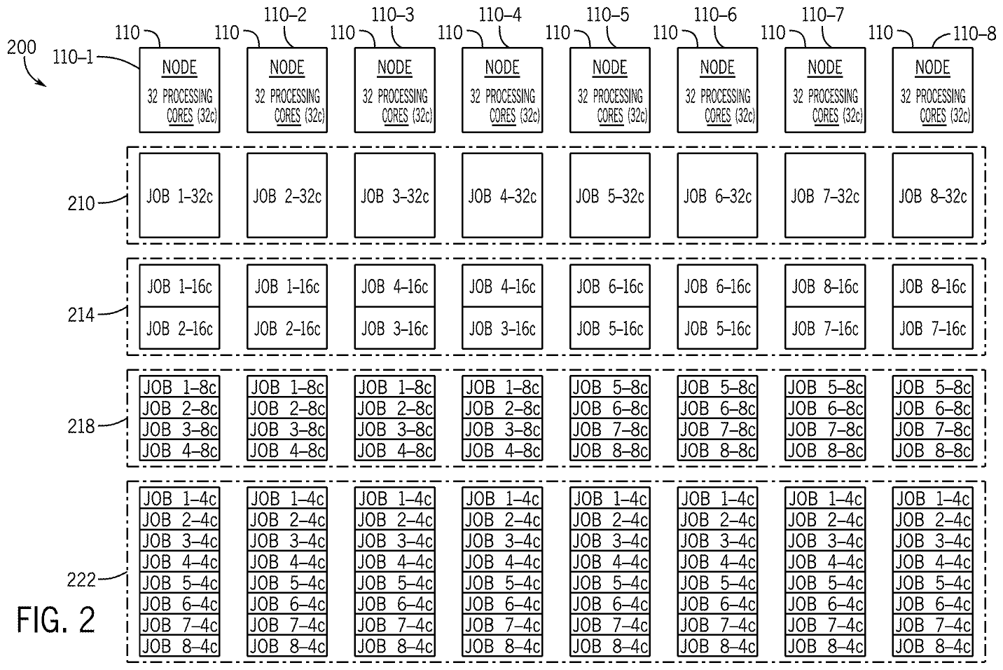

FIG. 2 is an illustration 200 of different scheduling examples for a set of eight available compute nodes 110 (i.e., compute nodes 110-1, 110-2, . . . 110-8) to process eight jobs (i.e., Jobs 1-8). For this example, each compute node 110 has thirty-two processing cores.

In the illustration 200, each compute node 110 is associated with a particular column of example processing core assignments (for different corresponding scheduling policies) for the compute node 110, with each scheduling example corresponding to a particular row. Row 210 is a scheduling example for thirty-two processing cores per job; row 214 is a scheduling example for sixteen processing cores per job; row 218 is a scheduling example for eight processing cores per job; and row 222 is a scheduling example for four processing cores per job. Moreover, in FIG. 2, the suffix “c” corresponds to “processing core,” as “32c” denotes thirty-two processing cores, “16c” represents sixteen processing cores, “8c” represents eight processing cores, and “4c” represents four processing cores. This notation, in combination with a particular job identifier represents the number of cores of a given compute node 110 that are processing ranks of that job. For example, in FIG. 2, “JOB 5-8c” represents that eight ranks of Job 5 are being processed by eight processing cores of a particular compute node 110.

Job striping-based scheduling for different scheduling policies is illustrated in rows 214, 218 and 222 of FIG. 2. For comparison, row 210 of FIG. 2 depicts node packing-based scheduling, which schedules each thirty-two rank job on the minimum number of compute nodes, i.e., all thirty-two ranks for each job are scheduled on a single compute node 110. Therefore, with the node packing-based scheduling, the thirty-two processing cores of the compute node 110-1 process the thirty-two ranks Job 1; the thirty-two processing cores of the compute node 110-2 process the thirty-two ranks Job 2; and so forth.

In the scheduling example of row 214, the job striping-based scheduling policy has a preference of sixteen processing cores per compute node 110 per job stripe. Pursuant to this policy, the compute node 110-1 is assigned to process ranks associated with two different jobs, i.e., sixteen processing cores of the compute node 110-1 are assigned to process sixteen ranks of Job 1; and sixteen processing cores of the compute node 110-1 are assigned to process sixteen ranks of Job 2. To process all thirty-two ranks of Jobs 1 and 2, the corresponding stripes of these jobs extend across the compute node 110-2. In this manner, as depicted in FIG. 2, sixteen processing cores of the compute node 110-2 are assigned to process the remaining sixteen ranks of Job 1, and sixteen processing cores of the compute node 110-2 are assigned to process the remaining sixteen ranks of Job 2. As another example, for Job 6, the job striping-based scheduling assigns sixteen processing cores of compute node 110-5 to process sixteen ranks of Job 5, and assigns sixteen processing cores of the compute node 110-5 to process sixteen ranks of Job 5. Jobs 5 and 6 are also striped across compute node 110-6 for this example, in that sixteen processing cores of the compute node 110-6 are scheduled to process sixteen ranks of Job 5, and sixteen processing cores of the compute node 110-6 are scheduled to process sixteen ranks of Job 6.

In the scheduling example of row 218, the job striping-based scheduling policy has a preference of eight processing cores per compute node 110 per job stripe. For example, for Job 3, eight processing cores on compute nodes 110-1, 110-2, 110-3 and 110-4 process different eight rank sets of Job 3. The compute nodes 110-1, 110-2, 110-3 and 110-4 also process different eight rank sets of Jobs 1, 2, 3 and 4.

Row 222 illustrates an example job striping-based scheduling policy that has a preference of four processing cores per compute node 110 per job stripe. With this policy, each of the eight compute nodes 110 has four processing cores assigned to four ranks of each of Jobs 1 to 8.

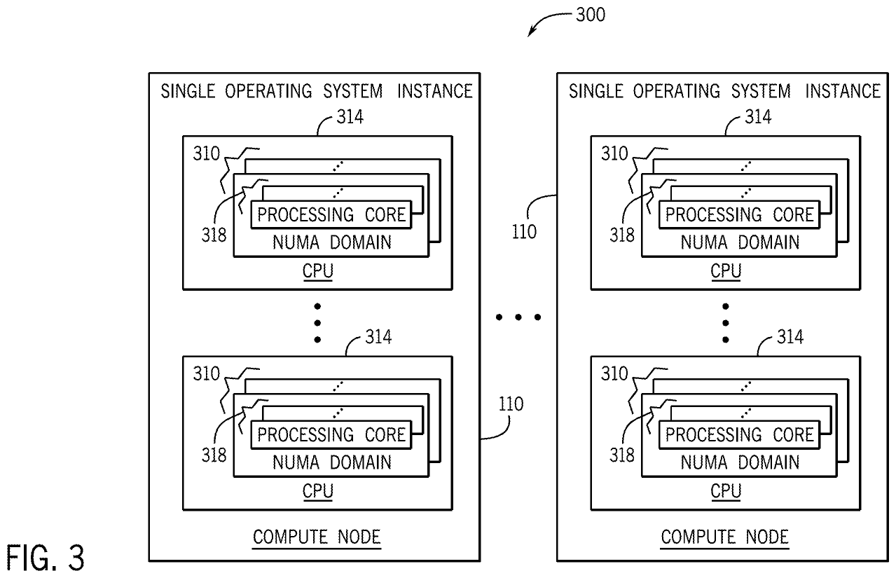

FIG. 3 is an illustration 300 of the compute nodes 110 in accordance with example implementations. Although two compute nodes 110 are shown in FIG. 3, the cluster 102 (FIG. 1) may contain more than two compute nodes 110 (e.g., tens, hundreds, if not more), in accordance with example implementations. The compute node 110 may take on many different forms and may be formed from all or part of a server, a server blade, a rack mounted server module, and so forth, depending on the particular implementation. As examples, a server may contain one, two or more compute nodes, depending on the particular implementation. As depicted in FIG. 3, in accordance with example implementations, the compute node 110 contains multiple processing cores 318, and the compute node 110 corresponds to a single OS instance, i.e., each processing core 318 of the compute node 110 is controlled by the same OS instance. Moreover, the compute node 110 may contain one or multiple multicore CPU semiconductor packages (or “sockets” or “chips”) 314. Although FIG. 3 depicts two CPU packages 314 per compute node 110, in accordance with further example implementations, a compute node 110 may contain a single CPU package 314 or more than two CPU packages 314. As a more specific example, in accordance with some implementations, the processing cores 318 of each CPU semiconductor package 314 access a local on-chip memory (not shown) of the CPU package 314.

The processing cores 318 on a given CPU semiconductor package 314 may be grouped into corresponding non-uniform memory access (NUMA) architecture domains 310 (called “NUMA domains” herein). In general, a NUMA architecture recognizes that processing nodes have faster access times to local memories than to non-local memory. Accordingly, in a NUMA architecture, processing performance may be optimized by the processing cores 318 being grouped according to the NUMA domains 310, where for each NUMA domain 310, the processing cores 318 of the NUMA domain 310 perform most of their computations using local memory accesses. As depicted in FIG. 3, in accordance with example implementations, there may be multiple NUMA domains 310 per CPU semiconductor package 314.

As an example, in accordance with some implementations, the CPU semiconductor package 314 may contain sixteen processing cores 318 and four NUMA domains 310; and for these implementations, the compute node 110 has thirty two processing cores 318 and eight, four core NUMA domains 310. It is noted that this is merely an example, as the number of processing cores 318 per CPU package 314, the number of NUMA domains 310 per CPU package 314, and the number of CPU package(s) 314 per compute node 110 may vary in accordance with the many potential implementations.

In accordance with further example implementations, the compute node 110 may contain one or multiple processing cores, other than CPU processing cores. For example, in accordance with further example implementations, a given compute node 110 may contain one or multiple graphics accelerator semiconductor packages (e.g., GPU semiconductor packages or “chips”), with each graphics accelerator semiconductor package containing GPU processing cores that correspond to the processing cores 318. As another example, in accordance with some implementations, a given compute node 110 may contain one or multiple FPGAs, where each FPGA corresponds to a processing core 318. Regardless of the particular form of the processing core 318, the processing cores 318 may be scheduled to process corresponding ranks of one or multiple jobs, as described herein.

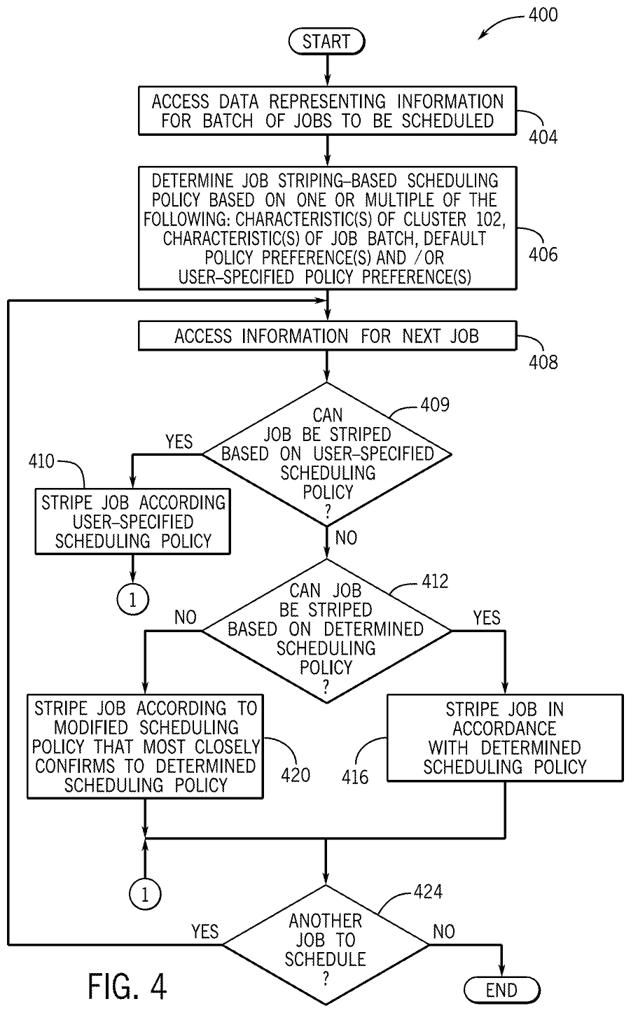

FIG. 4 depicts an example process 400 that may be used by the scheduler 120 to schedule jobs based on a job striping-based scheduling policy, in accordance with example implementations. Referring to FIG. 4 in conjunction with FIGS. 1 and 3, in accordance with example implementations, the process 400 includes the scheduler 120 accessing (block 404) data representing information for a group, or batch, of jobs to be scheduled on a set of idle compute nodes (or compute nodes 110 to be idle when processing of the jobs begins). The data that is accessed by the scheduler 120 may represent other information, such as user-specified preferences for the job scheduling policy (e.g., user-specified preferences that accompanied a job request); a classification or characteristics of the application(s) generating the jobs; and so forth.

Pursuant to the process 400, the scheduler 120 determines (block 406) a job striping-based scheduling policy to be applied in scheduling the batch of jobs. The determination of the particular job striping-based scheduling policy may be based on any of a number of different factors, such as one or more of the following: characteristics of the cluster 102 (e.g., number of processing cores per compute node 110), characteristics of the batch of jobs (e.g., the sizes (in ranks) of the jobs of the batch), default policy preferences, and user-specified policy preferences.

Next, the scheduler 120 may step through the jobs of the batch one at a time for purposes of striping the jobs across an available set of compute nodes 110. Here, an “available” compute node is a compute node 110 that is idle or will be idle when the scheduled processing by the compute node 110 beings. It is noted that although FIG. 4 depicts a sequential process for the scheduling, the scheduling of jobs may occur in parallel, in accordance with further implementations.

As depicted in FIG. 4, the scheduler 120 accesses (block 408) the information for the next job, such as, for example, information that identifies the number of ranks for the job. Pursuant to block 409, the scheduler 120 may determine whether the job may be striped according to a user-specified scheduling policy. If so, then, pursuant to block 410, the scheduler 120 stripes the job according to the user-specified scheduling policy; and then determines (decision block 424) whether there is another job to schedule. If there is another job to schedule, then control returns back to block 408 to schedule another job.

If the scheduler 120 determines (decision block 409) that the job cannot be striped according to the user-specified scheduling policy, then, pursuant to decision block 412, the scheduler 120 determines whether the job may be striped according to the “determined scheduling policy,” i.e., the scheduling policy that was determined in block 406. If so, then the scheduler 120, pursuant to block 416, stripes the job according to the determined scheduling policy; and control proceeds from block 416 to decision block 424 to determine if there are any more jobs to schedule.

In decision block 412, the scheduler 120 may determine that the job may not be striped according to the determined scheduling policy, and if so, the scheduler 120, pursuant to block 420, stripes the job according to a modified scheduling policy that most closely conforms to the originally determined scheduling policy that was determined in block 406. For example, the job may have twenty ranks; and the determined scheduling policy may specify a minimum of four processing cores per compute node 110 and specify eight compute nodes 110 per job stripe. Pursuant to block 420, for this example, the scheduler 120 may stripe the job across five (instead of eight) compute nodes 110, with four processing cores per compute node 110 being assigned five ranks of the job. Control proceeds from block 420 to decision block 424 to determine if there are any more jobs to schedule.

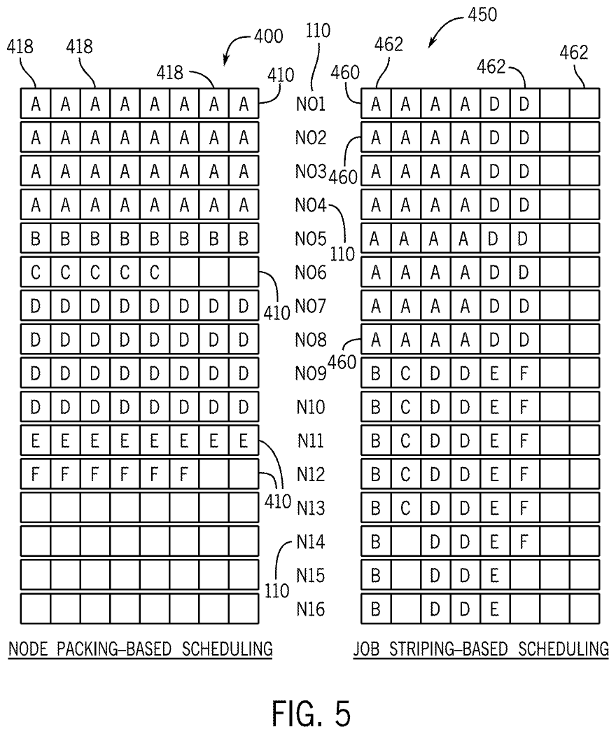

Referring to FIG. 5, as a more specific example of the application of the process 400, in accordance with some implementations, the scheduler 120 may apply job striping-based scheduling to generate a schedule 450 for six jobs (i.e., Job A, Job B, Job C, Job D, Job E and Job F) for sixteen compute nodes 110 (i.e., compute nodes 110 specifically denoted by N01, N02, N03 . . . to N16 in FIG. 5). Referring to FIG. 5 in conjunction with FIG. 3, for this example, there are two, sixteen processing core CPU packages 314 for each compute node 110 for a total of thirty-two processing cores 318 per compute node 110. Moreover, in accordance with an example implementation, the thirty-two processing cores 318 of each compute node 110 may be arranged in eight NUMA domains 310 (i.e., four processing cores 318 per NUMA domain 310). Overall, for this example implementation, the compute nodes 110 have a total of 512 processing cores 318 (i.e., sixteen compute nodes 110 multiplied by thirty two processing cores 318 per compute node 110) in 128 NUMA domains.

For this example, the ranks vary for the jobs that are to be scheduled: Job A has 128 ranks, which corresponds to 128 processing cores 318 and thirty-two NUMA domains 310; Job B has thirty-two ranks, which corresponds to thirty-two processing cores 318 and eight NUMA domains 310; Job C has twenty ranks, which corresponds to twenty processing cores 318 and five NUMA domains 310; Job D has 128 ranks, which corresponds to 128 processing cores 318 and thirty-two NUMA domains 310; Job E has thirty-two ranks, which corresponds to thirty-two processing cores 318 and eight NUMA domains 310; and Job F has twenty-four ranks, which corresponds to twenty-four processing cores 318 and six NUMA domains 310.

In the example schedule 450, each row 460 corresponds to a single compute node N01 to N16; and the elements, or boxes 462, of each row 460 corresponds to a NUMA domain and represents the particular job that is scheduled for that NUMA domain. For this example, the scheduler 120 determines the following scheduling policy: an eight compute nodes per job stripe and a minimum of one NUMA domain 310 (i.e., four processing cores 318) per node per job stripe. In accordance with further example implementations, the scheduler 120 may not take into account whether or not the processing cores 318 of a particular compute node are in a particular NUMA domain. Rather, the scheduling policy may specify a certain number of processing cores 318 per compute node per stripe, regardless of NUMA domain affiliation.

Pursuant to the example scheduling policy, for the first row that corresponds to the compute node N01, the scheduler 120 schedules four NUMA domains (denoted by the “A” boxes 462, which correspond to Job A) of the compute node N01 to process different sets of ranks of Job A; and two NUMA domains (denoted by the “D” boxes 462, which correspond to Job D) of the compute node N01 to process different sets of ranks of Job D. In FIG. 5, the blank boxes 462 denote unscheduled NUMA domains. Thus, for Jobs A and D, sixteen processing cores 318 per compute node are scheduled to process ranks for Job A; and eight processing cores 318 per compute node are scheduled to process ranks for Job D.

Due to the eight node per stripe preference for the determined scheduling policy, the scheduler 120 distributes, or stripes, the ranks for Job A across eight compute nodes, i.e., compute nodes N01, N02, N03, N04, N05, N06, N07 and N08. In a similar manner, the scheduler 120 stripes the ranks for Job B across eight compute nodes (i.e., compute nodes N09, N10, N11, N12, N13, N14, N15 and N16) such that one NUMA domain of each of these compute nodes processes four ranks of Job B; stripes the ranks for Job D across all sixteen compute nodes such that two NUMA domains of each of these compute nodes processes eight ranks of Job D; and stripes the ranks for Job E across eight compute nodes (i.e., compute nodes N09, N10, N11, N12, N13, N14, N15 and N16) such that one NUMA domain of each of these compute nodes processes four ranks of Job B.

Job C and Job F for this example each have less than thirty-two ranks. Accordingly, for each of these jobs, for the example scheduling policy, there are not enough ranks to distribute, or stripe, the ranks across eight nodes. Therefore, in accordance with example implementations, the scheduler 120 determines an alternate scheduling policy in which the one NUMA domain per compute node per job stripe is maintained, but the alternate scheduling policy deviates from the original scheduling policy and does not comply with the eight compute nodes per stripe preference. Therefore, in accordance with example implementations, the scheduler 120 distributes the twenty ranks of Job C across compute nodes N09, N10, N11, N12 and N13; and the scheduler 120 distributes the 24 ranks of Job F across compute nodes N09, N10, N11, N12, N13 and N14.

As a comparison to the job striping-based scheduling, FIG. 5 depicts an example schedule 400 for the same six Jobs A, B, C, D, E and F and available compute nodes N1 to N16 using node packing-based scheduling. In the example schedule 400, each row 410 corresponds to a compute node 110 (denoted by N01, N02, N03 . . . to N16), and the elements, or boxes 418, of each row 410 corresponds to a NUMA domain and represents the particular job that is scheduled for that NUMA domain. As shown, with the node packing-based scheduling, node packing is the priority, as the node packing packs the jobs on the minimal set of available compute nodes. For example, in accordance with the node packing-based scheduling, the ranks of Job A are packed in a minimal set of nodes, which here, are compute nodes N01, N02, N03 and N04. In other words, for this example, Job A has thirty-two ranks, and the thirty-two ranks are scheduled to be processed by the minimal set of nodes, i.e., four nodes at eight ranks per node. As also illustrated by the schedule 400, the eight ranks for Job B are scheduled for processing by a single compute node N05 (i.e., the minimal set of nodes to process Job B); the three ranks for Job C are scheduled for processing by a single compute node N06 (i.e., the minimal set of nodes to process Job C); the thirty-two ranks for Job D are scheduled for processing by compute nodes N07, N08, N09 and N10 (i.e., the minimal set of nodes to process Job D); and so forth. Moreover, with the node packing-based scheduling, some of the compute nodes N13 to N16 are unused, and each of the compute nodes N01 to N12 (for which processing is scheduled) is dedicated to processing the ranks of a single job.

In accordance with example implementations, the striping-based scheduling (represented by the schedule 450) may results in faster job processing times, due to such factors as better cache utilization per compute node and the tasks from multiple jobs being asynchronous in nature, thereby reducing local resource contention per compute node.

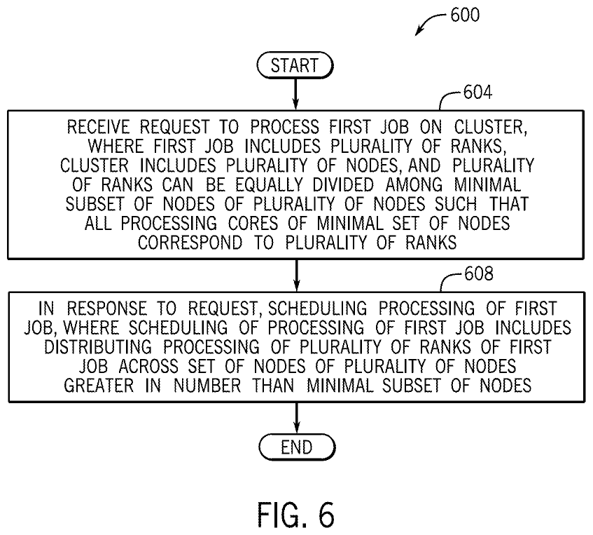

Referring to FIG. 6, in accordance with example implementations, a technique 600 includes receiving (block 604) a request to process a job on a cluster. The job includes a plurality of ranks, the cluster includes a plurality of nodes, and the plurality of ranks can be equally divided among a minimal subset of nodes of the plurality of nodes such that all processing cores and the minimal set of nodes correspond to the plurality of ranks. The technique includes, in response to the request, scheduling processing of the job. The scheduling of the processing of the job includes distributing processing of the plurality of ranks across a set of nodes of the plurality of nodes greater in number than the minimal subset of nodes.

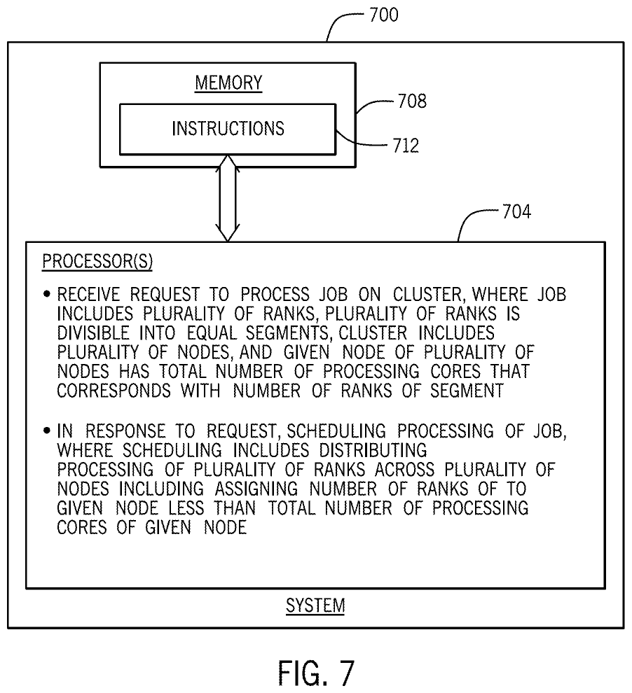

Referring to FIG. 7, in accordance with example implementations, a system 700 includes a processor 704 and a memory 708. The memory 708 stores instructions 712 that, when executed by the processor 704, cause the processor 704 to receive a request to process a job on a cluster. The job includes a plurality of ranks, the plurality of ranks is divisible into equal segments, the cluster includes a plurality of nodes, and a given node of the plurality of nodes has a total number of processing cores that correspond with the number of ranks of the segment. The instructions 712, when executed by the processor 704, further cause the processor 704 to, in response to the request, schedule processing of the job. The scheduling includes distributing processing of the plurality of ranks across the plurality of nodes including assigning a number of ranks to the plurality of ranks to the given node less than the total number of processing cores of the given node.

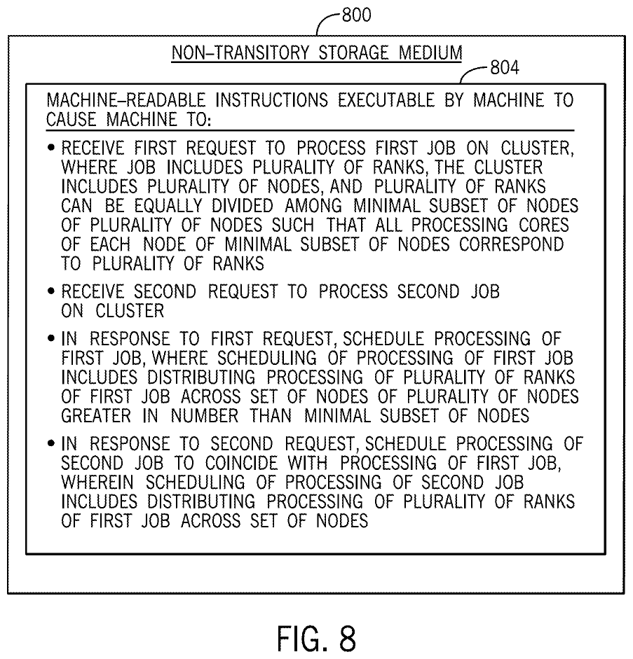

Referring to FIG. 8, in accordance with example implementations, a non-transitory storage medium 800 stores machine-readable instructions 804 that, when executed by a machine, cause the machine to receive a first request to process a first job on a cluster. The job includes a plurality of ranks, the cluster includes a plurality of nodes, and the plurality of ranks can be equally divided among a minimal subset of nodes of the plurality of nodes such that all processing cores of each node of the minimal subset of nodes correspond to the plurality of ranks. The instructions 804, when executed by the machine, further cause the machine to receive a second request to process a second job on the cluster. The instructions 804, when executed by the machine, further cause the machine to, in response to the first request, schedule processing of the first job, where the scheduling of the processing of the first job includes distributing processing of the plurality of ranks of the first job across the set of nodes of the plurality of nodes greater in number than the minimal subset of nodes; and in response to the second request, schedule processing of the second job to coincide with the processing of the first job. The scheduling of the processing of the second job includes distributing processing of the plurality of ranks of the second job across the set of nodes.

In accordance with example implementations, the technique includes scheduling processing of a second job, where the scheduling of processing of the second job includes distributing processing of a plurality of ranks of the second job across a set of nodes, and the processing of the plurality of ranks of the first job overlaps, on the same nodes, the processing of the plurality of ranks of the second job in time. A particular advantage is that the time to process the first and second jobs may be decreased, compared to node packing-based scheduling; and consequently, job processing performance and system throughput may be improved.

In accordance with example implementations, the scheduling further includes staggering start times of the plurality of ranks of the first job relative to the plurality of ranks of the second job. A potential advantage is that this ensures the asynchronous running of multiple tasks on the same nodes to reduce contention of local resources and to decrease job processing time. Consequently, job processing performance and system throughput may be improved

In accordance with example implementations, the plurality of nodes further includes a plurality of non-uniform memory access (NUMA) domains; and scheduling the processing of the job further includes distributing processing of the multiple ranks with at least some of the NUMA domains. A particular advantage is that distributing the processing across NUMA domains of different compute nodes may increase processing performance and increase system throughput.

In accordance with example implementations, each node corresponds to a different operating system instance of a plurality of operating system instances. A particular advantage is that the time for processing the first job may be decreased, as compared to scheduling the first job using node packing-based scheduling. Consequently, job processing performance and system throughput may be improved.

In accordance with example implementations, the scheduling may further include selecting a number of nodes to coincide with a predetermined nodes to job striping number. A particular advantage is that the time for processing the first job may be decreased, as compared to scheduling the first job using node packing-based scheduling. Consequently, job processing performance and system throughput may be improved.

In accordance with example implementations, the technique further includes determining a first scheduling policy for the plurality of jobs. The job includes attempting to schedule the first job based on the first scheduling policy and determining that the first job cannot be scheduled pursuant to the first scheduling policy. The technique includes determining a second scheduling policy based on characteristics of the first job and the first scheduling policy; and scheduling the first job based on the second scheduling policy. A particular advantage is that the time for processing the first job may be decreased, as compared to scheduling the first job using node packing-based scheduling. Consequently, job processing performance and system throughput may be improved.

In accordance with example implementations, the technique further includes determining a first scheduling policy and modifying the first scheduling policy to provide a second scheduling policy based on an observed performance of the cluster. A particular advantage is that the time for processing the first job may be decreased, as compared to scheduling the first job using node packing-based scheduling. Consequently, job processing performance and system throughput may be improved.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
receiving a request to process a first job on a cluster, wherein the first job comprises a plurality of ranks, the cluster comprises a plurality of nodes, and the plurality of ranks can be equally divided among a minimal subset of nodes of the plurality of nodes such that all processing cores of the minimal set of nodes correspond to the plurality of ranks; and
in response to the request, scheduling processing of the first job, wherein the scheduling of processing of the first job comprises distributing processing of the plurality of ranks across a set of nodes of the plurality of nodes greater in number than the minimal subset of nodes.

2. The method of claim 1, further comprising scheduling processing of a second job, wherein the scheduling of processing of the second job comprises distributing processing of a plurality of ranks of the second job across the set of nodes, wherein the processing of the plurality of ranks of the first job overlaps, on the same nodes, the processing of the plurality of ranks of the second job in time.

3. The method of claim 2, wherein the scheduling further comprises staggering start times of the plurality of ranks of the first job relatively to the plurality of ranks of the second job.

4. The method of claim 1, wherein:
the plurality of nodes further comprises a plurality of non-uniform memory access (NUMA) domains; and
scheduling the processing of the first job further comprises distributing processing of the multiple ranks of the plurality of ranks with at least some of the NUMA domains.

5. The method of claim 1, wherein each node of the set of nodes corresponds to a different operating system instance of a plurality of operating system instances.

6. The method of claim 1, wherein the scheduling further comprises selecting the set of nodes for the scheduling based on each node of the set of nodes being idle before processing of the first job begins.

7. The method of claim 1, wherein the first job is one of a plurality of jobs to be scheduled, and the scheduling further comprises:
determining a first scheduling policy for the plurality of jobs;
attempting to schedule the first job based on the first scheduling policy;
determining that the first job cannot be scheduled pursuant to the first scheduling policy;
determining a second scheduling policy based on characteristics of the first job and the first scheduling policy; and
scheduling the first job based on the second scheduling policy.

8. The method of claim 1, further comprising:
determining a first scheduling policy; and
modifying the first scheduling policy to provide a second scheduling policy based on an observed performance of the cluster.

9. The method of claim 1, wherein the scheduling further includes selecting the number of the set of nodes to coincide with a user-specified preference of a number of nodes per job stripe.

10. The method of claim 1, wherein each node of the plurality of nodes comprises a plurality of central processing unit (CPU) packages, a plurality of graphics processing unit (GPU) packages, field programable gate arrays (FPGAs), or other node accelerators.

11. The method of claim 1, wherein the first job is part of a plurality of jobs to be scheduled, the method further comprising:
determining a scheduling policy based on at least one characteristic of the cluster and at least one characteristic of the plurality of jobs; and
performing the scheduling in response to the scheduling policy.

12. A system comprising:
a processor; and
a memory to store instructions that, when executed by the processor, cause the processor to:
receive a request to process a first job on a cluster, wherein the first job comprises a plurality of ranks, the plurality of ranks is divisible into equal segments, the cluster comprises a plurality of nodes, and a given node of the plurality of nodes has a total number of processing cores that corresponds with the number of ranks of the segment;
in response to the request, scheduling processing of the first job, wherein the scheduling comprises distributing processing of the plurality of ranks across the plurality of nodes including assigning a number of ranks of the plurality of ranks to the given node less than the total number of processing cores of the given node.

13. The system of claim 12, wherein the instructions, when executed by the processor, further cause the processor to:
schedule processing of a second job, comprising distributing processing of a plurality of ranks of the second job across the plurality of nodes, wherein the processing of the plurality of ranks of the first job overlaps in time with the processing of the plurality of ranks of the second job.

14. The system of claim 12, wherein each node of the plurality of nodes corresponds to a different operating system instance of a plurality of operating system instances.

15. The system of claim 12, wherein the instructions, when executed by the processor, further cause the processor to schedule processing of the first job based on a determined scheduling policy, wherein the determined scheduling policy specifies a number of nodes per job stripe.

16. The system of claim 12, further comprising:
a plurality of servers comprising the plurality of nodes, wherein a given server of the plurality of servers comprises the given node and another node of the plurality of nodes.

17. A non-transitory storage medium storing machine-readable instructions that, when executed by a machine, cause the machine to:
receive a first request to process a first job on a cluster, wherein the first job comprises a plurality of ranks, the cluster comprises a plurality of nodes, and the plurality of ranks can be equally divided among a minimal subset of nodes of the plurality of nodes such that all processing cores of each node of the minimal subset of nodes correspond to the plurality of ranks;
receive a second request to process a second job on the cluster;
in response to the first request, schedule processing of the first job, wherein the scheduling of processing of the first job comprises distributing processing of the plurality of ranks of the first job across a set of nodes of the plurality of nodes greater in number than the minimal subset of nodes; and
in response to the second request, schedule processing of the second job to coincide with the processing of the first job, wherein the scheduling of processing of the second job comprises distributing processing of the plurality of ranks of the second job across the set of nodes.

18. The storage medium of claim 17, wherein the instructions, when executed by the machine, further cause the machine to determine a first scheduling policy based on characteristics of the plurality of nodes and characteristics of the first job and the second job, and schedule processing of the first job and the second job in response to the first scheduling policy.

19. The storage medium of claim 18, wherein the instructions, when executed by the machine, further cause the machine to:
observe a performance of the cluster;
modify the first scheduling policy based on the performance to provide a second scheduling policy; and
schedule another job based on the second scheduling policy.

20. The storage medium of claim 17, wherein the instructions, when executed by the machine, further cause the machine to determine a scheduling policy based on at least one user-specified preference.
